(19) United States
(12) Patent Application Publication
(10) Pub. No.: US 2008/0146389 A1
(43) Pub. Date: Jun. 19, 2008

(54) Belt gear positioning device

(76) Inventor: Oliver Sir, Magalia, CA (US)

Correspondence Address: Oliver Sir, P.O. Box 90, Tainan City, 70499, omitted

(21) Appl. No.: 11/640,376

(22) Filed: Dec. 18, 2006

(51) Int. Cl. F16H 7/18; F16H 7/02

(52) U.S. Cl. 474/8

(57) ABSTRACT

A belt gear-positioning device to be assembled on gear(s) includes positioning rod(s), securing fixture(s), wing nut(s) and positioning strip(s). By turning and adjusting the positioning rod(s), the securing fixture(s) can be respectively engaged tightly in the spoke spaces of the gear(s) for securing the gear(s), avoiding damaging the surfaces of the teeth of the gear(s) and making it possible to safely carry out timing belt removal and/or replacement.

### BACKGROUND OF THE INVENTION

While the preferred embodiment of the invention has been described in detail in the following, it will be recognized and understood that various modifications may be made therein (number and/or configuration of positioning rods, securing fixtures, positioning strips, clamps and hardware, etc.,) and the appended claims are intended to cover all such modifications that may fall within the spirit and scope of the invention.

1. Field of the Invention

This invention relates to a timing belt gear positioning device, particularly to one provided with securing fixture(s) and positioning rod(s) combined together. The securing fixture(s) can be respectively engaged tightly in the spoke spaces of gear(s) to secure the gear(s) only by adjusting the positioning rod(s), facilitating replacing of a timing belt and causing no damage to the teeth of the gears.

2. Description of the Prior Art

Generally, to disassemble a timing belt from a timing belt gear, it is necessary to secure the gears from rotating in relationship to one another. This is done so as to maintain the correct timing.

A conventional positioning device 1 for positioning two belt gears, as shown in FIG. 1, includes a fixing block 10, an adjusting block 11 and a positioning strip 12. The fixing block 10 and the adjusting block 11 are positioned reversely between two gears, and the positioning strip 12 is assembled on the fixing block 10 and the adjusting block 11 and bored with a lengthwise slide groove 13. A locking rotary member 14 is inserted through the slide groove 13 of the positioning strip 12 and firmly locked on the fixing block 10, and an adjusting rotary member 15 is inserted through the slide groove 13 of the positioning strip 12 and fixed on the adjusting block 11. In using, the fixing block 10 and the adjusting block 11 are firstly positioned between the two gears 16, letting the outer wall surface of the fixing block 10 closely rest against the teeth 17 of one gear 16. Then, unscrew the adjusting rotary member 15 and move the adjusting block 11 to let its outer wall surface closely rest against the teeth 17 of the other gear 16, and lastly screw tight the adjusting rotary member 15 for stabilizing the space between the two gears 16.

However, the fixing block 10 and the adjusting block 11 of the conventional belt gear positioning device 1 respectively have their outer wall surfaces resting against the teeth 17 of the two gears 16; therefore, the surfaces of the gear teeth 17 are likely to become damaged. As a result, this damage can, in turn, cause damage and possible breakage of said timing belt, causing the cam shaft(s) to spin freely, thus potentiating damage to the valves, head and piston (engine top end).

### SUMMARY OF THE INVENTION

The objective of this invention is to offer a belt gear positioning device able to secure the gear(s) from rotating in order to facilitate replacement of the timing belt, making it impossible to damage the teeth of the gear(s).

The belt gear-positioning device to be assembled on the gear(s) in the present invention includes positioning rod(s) and securing fixture(s), combined together. By adjusting the positioning rod(s), the securing fixture(s) can be respectively engaged tightly in the spoke spaces of the two gears to secure the gear(s) from rotation for facilitating replacement of the timing belt.

### BRIEF DESCRIPTION OF DRAWINGS

This invention will be better understood by referring to the accompanying drawings, wherein:

FIG. 1 is a cross-sectional view of a conventional belt gear-positioning device in a using condition;

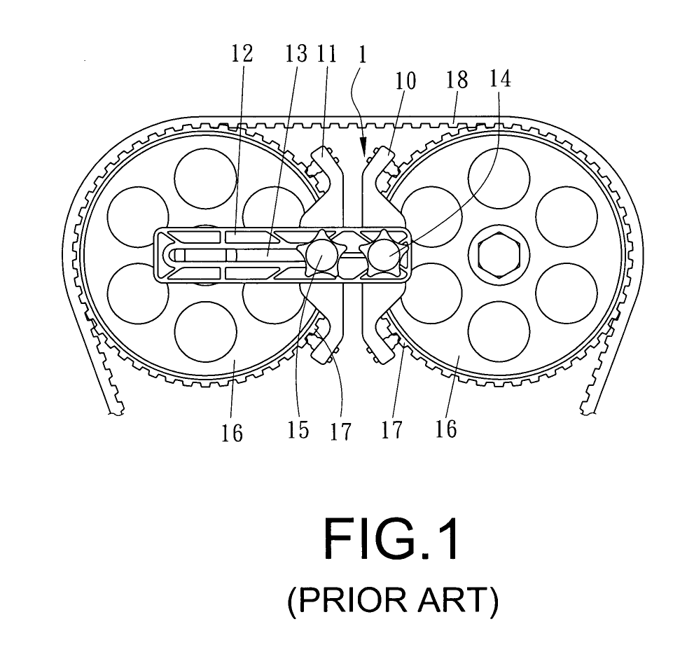

FIG. 2 is an exploded perspective view of a belt gear-positioning device in the present invention;

FIG. 3 is a perspective view of the belt gear-positioning device in the present invention;

FIG. 4 is a cross-sectional view of adjusting blocks adjusted in position in the present invention;

FIG. 5 is a perspective view of the belt gear positioning device fixing two gears in position in the present invention; and

FIG. 6 is a front view of the belt gear-positioning device fixedly positioning the two gears in the present invention.

### DETAILED DESCRIPTION OF THE PREFERRED EMBODIMENT

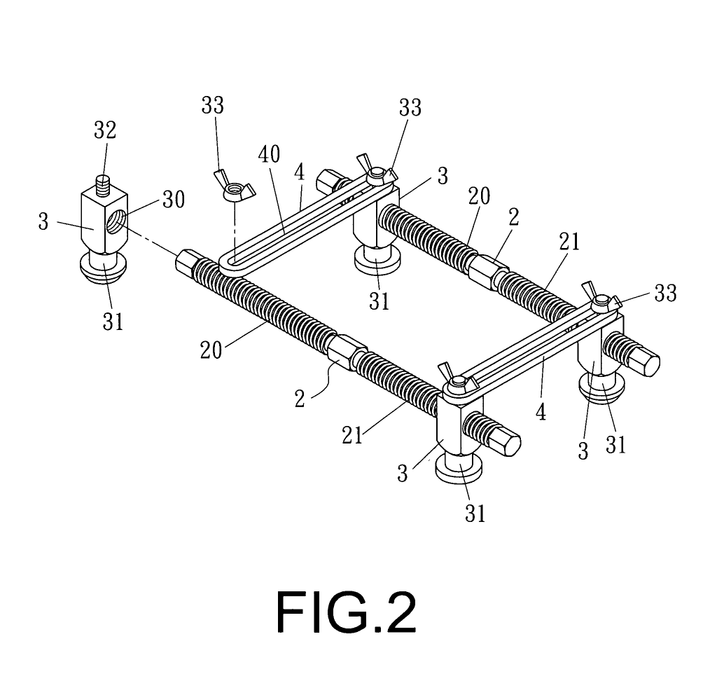

A preferred embodiment of a belt gear-positioning device in the present invention, as shown in FIG. 2, includes two polygonal positioning rods 2, four securing fixtures 3 and two positioning strips 4 as main components combined together.

The two polygonal positioning rods 2 have there opposite ends respectively provided with reverse male threads 20, 21.

The four securing fixtures 3 are respectively fitted on the opposite ends of the two positioning rods 2, respectively bored with a through threaded hole 30 in the side wall and an annular engage groove 31 around the lower portion. Each securing fixture 3 further has its topside fixed with a small threaded rod 32 screwed with a wing nut 33.

The two positioning strips 4 respectively have the opposite ends assembled on two opposite securing fixtures 3 between the two positioning rods 2, and each positioning strip 4 is bored with a lengthwise slide slot 40.

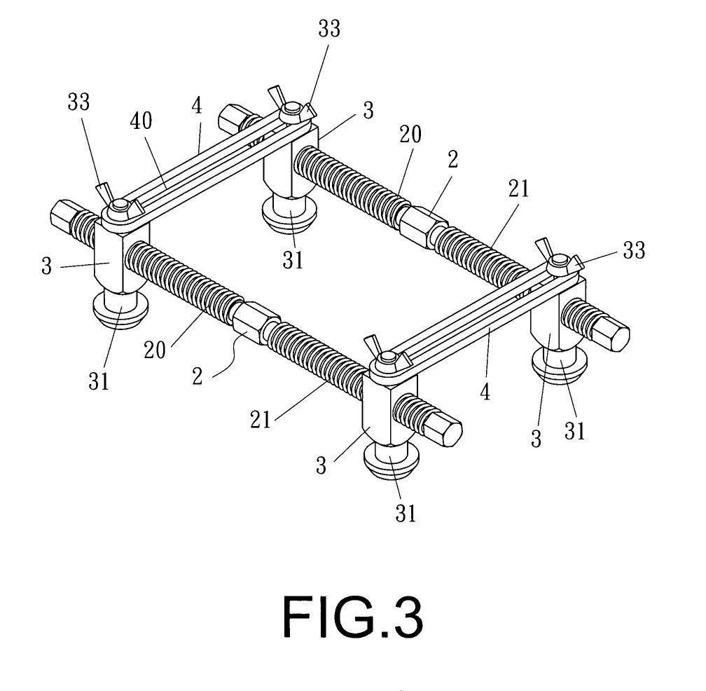

In assembling, referring to FIGS. 2 and 3, firstly, the four securing fixtures 3 are respectively fitted with the four ends of the two positioning rods 2 by screwing the male threads 20, 21 of the positioning rods 2 with the threaded holes 30 of the positioning blocks 3. Next, the two positioning strips 4 have their opposite ends respectively positioned on the topsides of two opposite securing fixtures 3 between the two positioning rods 2, letting the small threaded rod 32 of the positioning block 3 inserted through the slide slot 40 of the positioning strip 4. Then, the wing nuts 33 are respectively screwed with the threaded rods 32 of the securing fixtures 3 to fix the two positioning strips 4 in position and stabilize the space between the two positioning rods 2, thus finishing assembly of the belt gear positioning device.

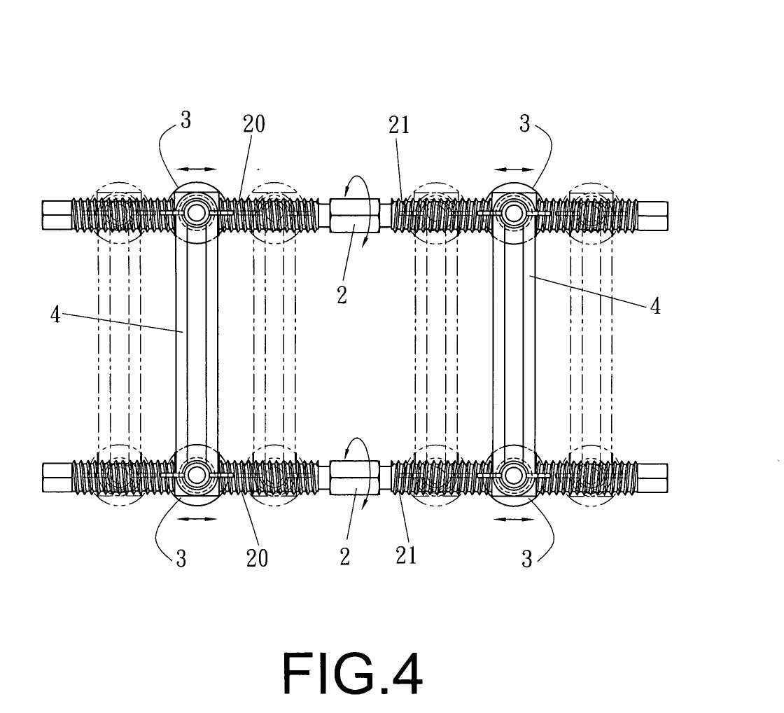

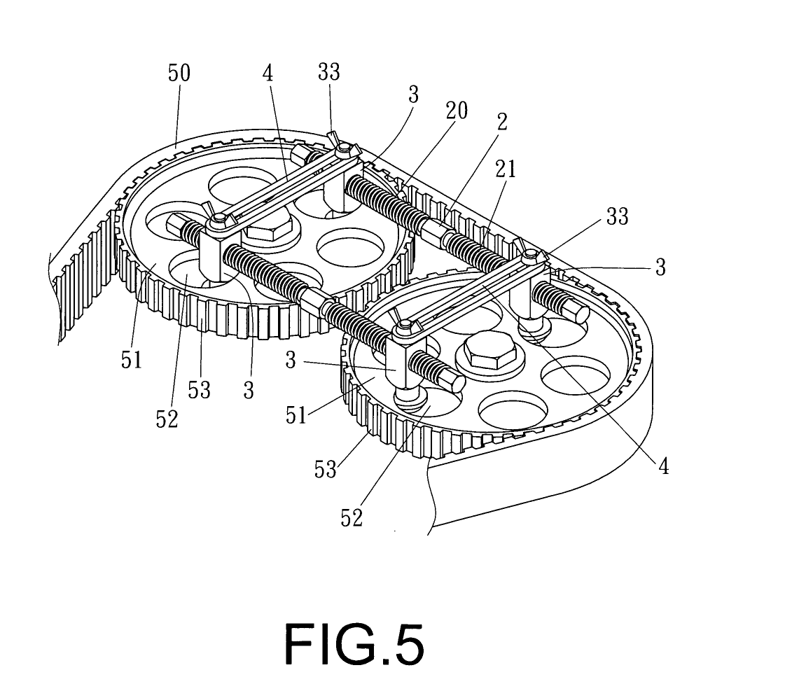

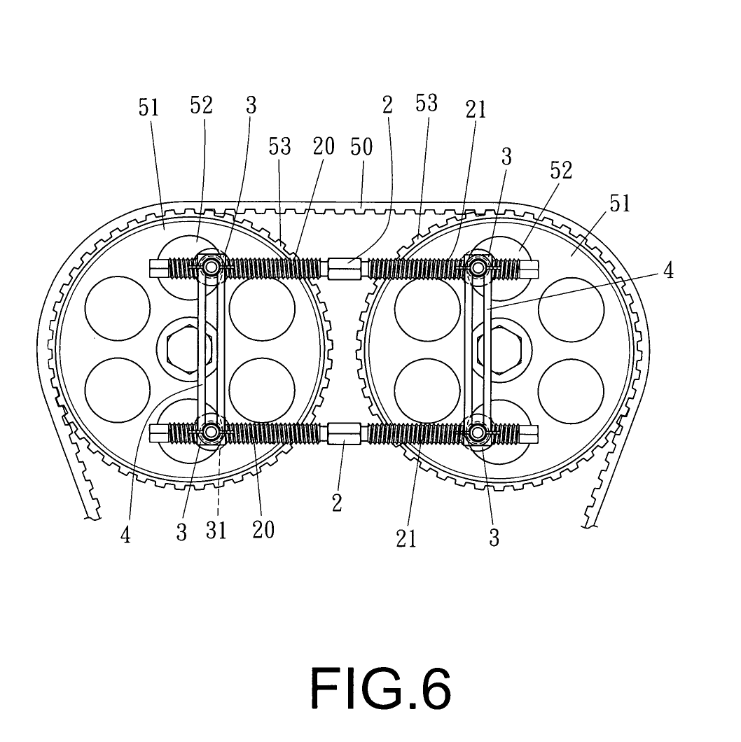

In using, as shown in FIGS. 4, 5 and 6, to replace the belt 50 with a new one, firstly, unscrew the wing nuts 33 and have the lower portions of the four securing fixtures 3 respectively inserted in the spoke spaces 52 of the two gears 51. Next, turn and adjust the two positioning rods 2 to let the securing fixtures 3 on the opposite ends of the two positioning rods 2 moved reversely along the reverse male threads 20, 21 of each positioning rod 2, as shown in FIG. 4. When the two positioning rods 2 are turned clockwise, the two opposite securing fixtures 3 on each positioning rod 2 will be respectively moved toward the intermediate portion of the positioning rod 2. On the contrary, when the two positioning rods 2 are turned counterclockwise, the two opposite securing fixtures 3 on each positioning rod 2 will be respectively moved toward the two outer ends of the positioning rod 2. Thus, by turning and adjusting the two positioning rods 2, the securing fixtures 3 on the positioning rods 2 can be adjusted in position to let their annular engage grooves 31 respectively engaged tightly on the inner walls of the spoke spaces 52 of the two gears 51, letting the small threaded rod 32 at the topside of each securing fixture 3 positioned in the slide slot 40 of the positioning strip 4. After the space between the two positioning rods 2 is properly adjusted, the wing nuts 33 are tightly screwed on the positioning strips 4 to stabilize the space between the two positioning rods 2 and the space between the two opposite securing fixtures 3, thus fixing the space between the two gears 51.

As can be understood from the above description, this invention has the following advantages.

1. The space between two gears 51 can easily be fixed in position, facilitating replacing of the belt 50.

2. The space between two gears 51 can be kept steady only by having the four securing fixtures respectively engaged tightly on the inner walls of the spoke spaces 52 of the two gears 51 without any component contacting with the teeth 53 of the gears 51, avoiding damaging the surfaces of the teeth 53 of the two gears 51 and making it possible to safely carry out timing belt removal and/or replacement.

While the preferred embodiment of the invention has been described above, it will be recognized and understood that various modifications may be made therein and the appended claims are intended to cover all such modifications that may fall within the spirit and scope of the invention.

What is claimed is:

1. A belt gear positioning device to be assembled on a gear(s), said device comprising positioning rod(s) and securing fixture(s), said securing fixture(s) able to be respectively engaged tightly in the spoke spaces of said gear(s) by turning and adjusting said positioning rod(s), said positioning rod(s) combined with said securing fixture(s) to secure said gear(s) from rotating.

2. The belt gear positioning device as claimed in claim 1, wherein said belt gear positioning device is provided with positioning rod(s), said positioning rod(s) having its opposite ends respectively provided with polygonal male threads, said positioning rod(s) having their opposite ends respectively fitted with one said securing fixture, each said securing fixture having its side wall bored with a through threaded hole and its lower portion cut with an annular engage groove, each said securing fixture having its topside fixed with a small threaded rod screwed with a wing nut, positioning strip(s) assembled with opposite said securing fixture(s) on said positioning rod(s), each said positioning strip bored with a lengthwise slide slot.
